(19) United States
(12) Patent Application Publication
(10) Pub. No.: US 2016/0016753 A1
(43) Pub. Date: Jan. 21, 2016

(54) IMAGE FORMING APPARATUS, METHOD OF CONTROLLING THE SAME, AND STORAGE MEDIUM

(71) Applicant: CANON KABUSHIKI KAISHA, Tokyo (JP)

(72) Inventor: Ayumi Suzuki, Kawasaki-shi (JP)

(21) Appl. No.: 14/798,776

(22) Filed: Jul. 14, 2015

(30) Foreign Application Priority Data
Jul. 16, 2014 (JP) 2014-145782
Jun. 19, 2015 (JP) 2015-123830

(51) Int. Cl. B65H 37/04; G05B 15/02; H04N 1/00; G06K 15/02; G06K 15/16; B65H 43/00; G06K 15/00

(52) U.S. Cl. CPC B65H 37/04; B65H 43/00; G05B 15/02; G06K 15/404; G06K 15/408; G06K 15/021; G06K 15/16; G06K 15/4065; H04N 1/00639; H04N 2201/0094

(57) ABSTRACT

An image forming apparatus that is capable of preventing failure of binding of printed sheets. A PDL processor determines based on print data whether or not needleless binding has been set. If needleless binding has been set, the PDL processor acquires a sheet type of each page from the print data. The PDL processor determines whether the sheet type of the page is needleless binding executable. The PDL processor replaces a sheet type which is determined to be needleless binding unexecutable, with a sheet type which is needleless binding executable. A post-processing apparatus performs needleless binding on the bundle of printed sheets in which any needleless binding unexecutable sheet is replaced with a sheet of the needleless binding executable type.

### BACKGROUND OF THE INVENTION

1. Field of the Invention

The present invention relates to an image forming apparatus, a method of controlling the same, and a storage medium, and more particularly to a technique for controlling an image forming apparatus equipped with a function of binding a bundle of sheets having images printed thereon without using staples or an image forming apparatus connected to a sheet processing apparatus having the function.

2. Description of the Related Art

There is a case where an image forming apparatus having a copy function and a printer function has a sheet processing apparatus connected thereto which performs post-processing on a bundle of sheets printed by the image forming apparatus. The sheet processing apparatus includes, for example, a stapler for binding a sheet bundle using metal needles.

In recent years, in view of environmental and safety concerns, there is employed a method of binding a sheet bundle without using staple needles (hereinafter referred to as the “needleless binding”) as an alternative method to stapling that uses staple needles. For example, there have been put into practical use a method of cutting two adjacent portions of printed matter into respective tongue shapes and inserting the two tongue-shaped portions into a hole formed by cutting one of them, to thereby bind the printed matter (see Japanese Patent Laid-Open Publication No. H08-300847), and a method of binding a bundle of printed sheets by squeezing them through pressing a special blade against the same.

However, according to the method of binding a sheet bundle without using metal needles, a binding force is weak, and therefore the maximum number of sheets of a bundle that can be bound at a time is small, compared with stapling using metal needles. To solve this problem, in Japanese Patent Laid-Open Publication No. 2014-8642, there is proposed a configuration for selecting which of the binding methods is to be used, according to a sheet thicknesses, a sheet type, or the like, by taking the features of stapling and needleless binding into consideration.

Further, in the method of binding a sheet bundle by squeezing sheets through pressing a special blade against the sheet surface of the bundle, even when the number of sheets is small, there is a fear that binding processing fails depending on the properties of the sheet surface.

### SUMMARY OF THE INVENTION

The present invention provides an image forming apparatus that is capable of preventing failure of binding of printed sheets.

In a first aspect of the present invention, there is provided an image forming apparatus comprising a printing unit configured to be capable of printing images on sheets of a plurality of types, a feeding unit configured to feed a sheet of a designated type to the printing unit, and a control unit configured to, in a case where binding processing is designated for a bundle of sheets on which images are to be printed by the printing unit, and also the sheet of the designated type is a sheet which cannot be bound by the binding processing, control the feeding unit to feed a sheet which can be bound by the binding processing in place of the sheet of the designated type.

In a second aspect of the present invention, there is provided a method of controlling an image forming apparatus including a printing unit capable of printing images on sheets of a plurality of types, comprising feeding a sheet of a designated type to the printing unit, and controlling, in a case where binding processing is designated for a bundle of sheets on which images are to be printed by the printing unit, and also the sheet of the designated type is a sheet which cannot be bound by the binding processing, said feeding to feed a sheet which can be bound by the binding processing in place of the sheet of the designated type.

In a third aspect of the present invention, there is provided a non-transitory computer-readable storage medium storing a computer-executable program for executing a method of controlling an image forming apparatus including a printing unit capable of printing images on sheets of a plurality of types, wherein the method comprises feeding a sheet of a designated type to the printing unit, and controlling, in a case where binding processing is designated for a bundle of sheets on which images are to be printed by the printing unit, and also the sheet of the designated type is a sheet which cannot be bound by the binding processing, said feeding to feed a sheet which can be bound by the binding processing in place of the sheet of the designated type.

According to the present invention, it is possible to prevent failure of the binding process.

Further features of the present invention will become apparent from the following description of exemplary embodiments (with reference to the attached drawings).

### BRIEF DESCRIPTION OF THE DRAWINGS

FIG. 1 is a block diagram of the hardware configuration of an image forming apparatus according to a first embodiment of the present invention.

FIG. 2 is a block diagram of the software configuration of the image forming apparatus appearing in FIG. 1.

FIGS. 3A to 3C are diagrams showing examples of a method of binding a sheet bundle by needleless binding, in which FIG. 3A is a cross-sectional view of an upper die and a lower die in a state before the sheet bundle is bound, FIG. 3B is a cross-sectional view of the upper die and the lower die at a time when the sheet bundle is bound, and FIG. 3C is a cross-sectional view of the sheet bundle (printed matter) bound by a needleless binding section.

FIG. 4 is a diagram of an example of a sheet bundle bound by needleless binding.

FIG. 5A is a diagram of an example of a sheet information-setting screen displayed on a touch panel of a console section of the image forming apparatus.

FIG. 5B is a diagram of an example of a needleless binding executability information-setting screen displayed on the touch panel of the console section of the image forming apparatus.

FIG. 6 is a diagram of an example of a substitute sheet-setting screen displayed on the touch panel of the console section of the image forming apparatus.

FIG. 7 is a diagram of an example of a sheet information list stored in an HDD of the image forming apparatus.

FIG. 8 is a diagram useful in explaining a method of performing replacement with a needleless binding unexecutable-time substitute sheet.

FIG. 9 is a flowchart of a sheet type replacement process in the first embodiment.

FIG. 10 is a diagram of an example of a needleless binding unexecutable-time sheet replacement mode-setting screen displayed on a touch panel of a console section of an image forming apparatus according to a second embodiment.

FIG. 11 is a diagram useful in explaining a method of performing replacement with a needleless binding unexecutable-time substitute sheet, according to the second embodiment.

FIG. 12 is a flowchart of a replacement process performed in a case where a sheet of a leading page has been set to be replaced on a needleless binding unexecutable-time sheet replacement mode-setting screen.

FIG. 13 is a flowchart of a replacement process performed in a case where replacement of a sheet of the immediately preceding page has been set on the needleless binding unexecutable-time sheet replacement mode-setting screen.

FIG. 14 is a flowchart of a replacement process performed in a case where replacement of a sheet of the immediately following page has been set on the needleless binding unexecutable-time sheet replacement mode-setting screen.

FIG. 15 is a diagram of an example of a needleless binding unexecutable-time automatic sheet type replacement-setting screen displayed on a touch panel of a console section of an image forming apparatus according to a third embodiment.

FIG. 16 is a flowchart of a replacement process performed in a case where it is possible to select whether or not to execute automatic replacement of a sheet type, on the needleless binding unexecutable-time automatic sheet type replacement-setting screen.

FIG. 17 is a diagram of an example of a sheet type replacement confirmation screen displayed on a touch panel of a console section of an image forming apparatus according to a fourth embodiment, for confirming whether or not to replace a needleless binding unexecutable sheet type with plain paper.

FIG. 18 is a flowchart of a replacement process performed in a case of prompting a user to confirm whether or not to perform sheet type replacement at a needleless binding unexecutable time.

### DESCRIPTION OF THE EMBODIMENTS

The present invention will now be described in detail below with reference to the accompanying drawings showing embodiments thereof.

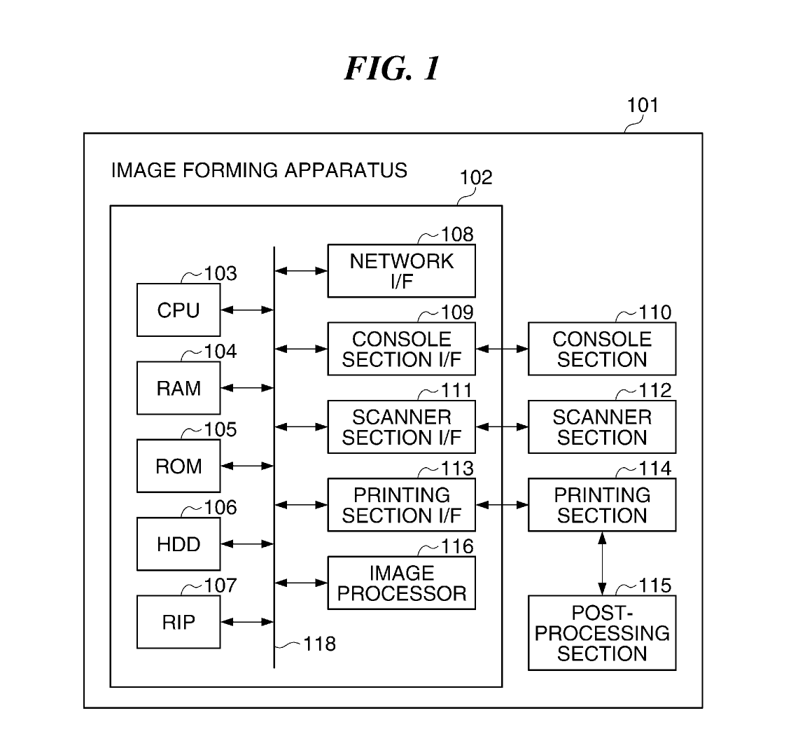

FIG. 1 is a block diagram of the hardware configuration of an image forming apparatus according to a first embodiment of the present invention.

Referring to FIG. 1, the image forming apparatus 101 is comprised of a controller 102, a console section 110, a scanner section 112, a printing section 114, and a post-processing section 115.

The controller 102 includes a CPU 103, a RAM 104, a ROM 105, an HDD 106, a raster image processor (RIP) 107, a network interface 108, a console section interface 109, a scanner section interface 111, a printing section interface 113, and an image processor 116, which are connected to each other by a system bus 118.

The CPU 103 performs centralized control of various types of units, including the above-mentioned components, which are connected to the system bus 118, to thereby control copy processing, print processing, and so forth. The ROM 105 stores various parameters and programs necessary for the CPU 103 to perform various processes. The RAM 104 functions as a main memory and a work area for the CPU 103, and further is also used as a buffer area for storing image data necessary for scanning, printing, and so forth.

The HDD 106 is a nonvolatile memory which temporarily stores image data received via the network interface 108, and is accessed from modules, as a swap area for the RIP 107 and the image processor 116.

The RIP 107 has a function of rasterizing page description language (PDL) data into raster image data.

The console section interface 109 is connected to the console section 110, and provides an interface for notifying the CPU 103 of information input from the console section 110, via the system bus 118, and controlling display information sent from the CPU 103 to the console section 110.

The scanner section interface 111 is connected to the scanner section 112, and provides an interface for controlling transmission and reception of control commands to and from the scanner section 112, and reception of image data optically scanned by the scanner section 112.

The printing section interface 113 is connected to the printing section 114 and the post-processing section 115 via the printing section 114, and provides an interface for controlling the printing section 114 and the post-processing section 115. For example, the printing section interface 113 controls transmission and reception of control commands to and from the printing section 114 and the post-processing section 115, and transmission of print data to be printed by the printing section 114, and the like. Note that it is assumed that in the present embodiment, a print job as well is included in the print data.

The image processor 116 performs image processing, such as scaling, rotation, color conversion, and smoothing, on image data scanned by the scanner section 112 and image data externally received via the network interface 108.

The console section 110 includes hard keys and a touch panel, and realizes a display function and an operation function.

The post-processing section 115 performs post-processing, such as stapling, needleless binding, punching, and saddle-stitching, on a bundle of sheets discharged after the sheets are printed by the printing section 114. The sheets include plain paper, thin paper, one-side coated paper, OHP films, recycled paper, index paper, double-side coated paper, and so forth.

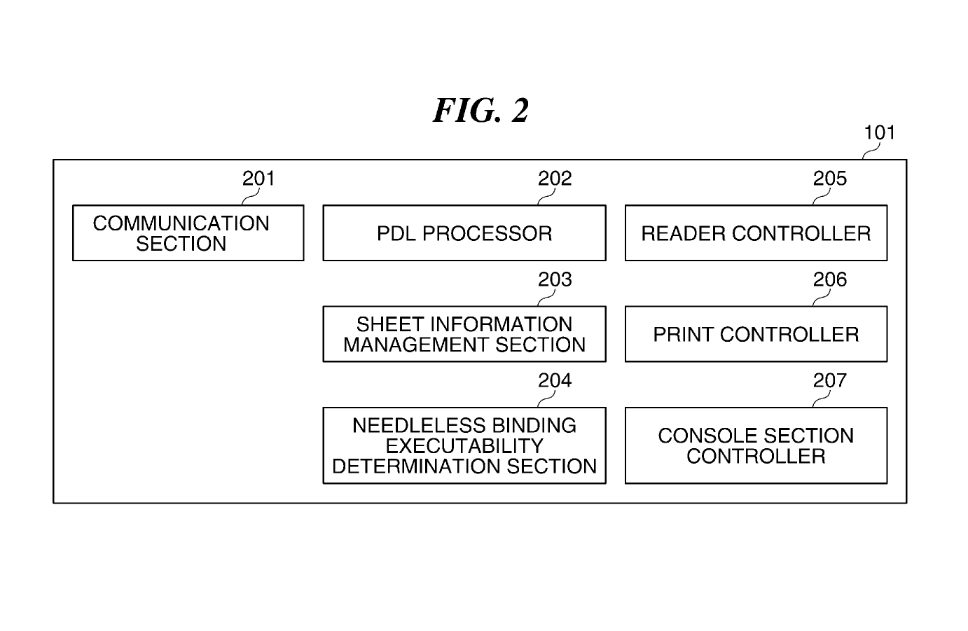

FIG. 2 is a block diagram of the software configuration of the image forming apparatus 101 shown in FIG. 1. Note that reference numerals 201 to 207 in FIG. 2 denote program modules which are stored in the ROM 105, and are loaded into the RAM 104, for execution by the CPU 103.

A communication section 201 has a function of controlling transmission and reception of print data.

A PDL processor 202 analyzes print data represented by a page description language (PDL), and acquires print settings, such as a sheet size, a sheet type, and sheet processing, such as needleless binding, which are set for the whole print data and each page. Then, in a case where the print settings include needleless binding and also there is a page which is set to a sheet type determined to be needleless binding unexecutable, the PDL processor 202 replaces a sheet type set for the page with a sheet type which is needleless binding executable (i.e. which can be subjected to needleless binding).

The RIP 107 generates raster image data based on the information analyzed by the PDL processor 202, and a print controller 206 controls the printing section 114 and the post-processing section 115, whereby printed matter is produced as instructed.

A sheet information management section 203 has a function of managing a sheet information list stored in the HDD 106. The sheet information list and sheet information registered in the sheet information list will be described in detail hereinafter.

A needleless binding executability determination section 204 has a function of inquiring the sheet information management section 203 about sheet information, and determining whether or not a sheet type set in the sheet information is needleless binding executable. In the present embodiment, needleless binding is performed by a method in which the sheet bundle is pressure-bonded into a bound state by applying pressure thereto from the direction of thickness thereof using protruding blades and recessed blades, and therefore the number, basis weight, and surface properties of sheets suitable for needleless binding are limited. For example, in a case where a bundle of sheets includes an OHP film, coated paper, or the like, which has smooth surfaces, if the sheets are bound by needleless binding, a pressure-bonding force between the sheets is weak, so that the sheets are liable to be peeled off. To cope with this, the needleless binding executability determination section 204 determines, based on the sheet information of sheets of a sheet bundle, whether or not each sheet is needleless binding executable.

A reader controller 205 has a function of controlling the scanner section interface 111 and the scanner section 112.

The print controller 206 has a function of controlling the printing section interface 113, the printing section 114, and the post-processing section 115.

A console section controller 207 has a function of controlling the console section interface 109 and the console section 110. For example, the console section controller 207 receives an input from the console section 110, to thereby receive e.g. an instruction for operation of the image forming apparatus 101 and an instruction for changing an operation mode. Further, the console section controller 207 has a function of causing the state of the image forming apparatus 101, sheet information registered in the sheet information list, and so forth to be displayed on the touch panel.

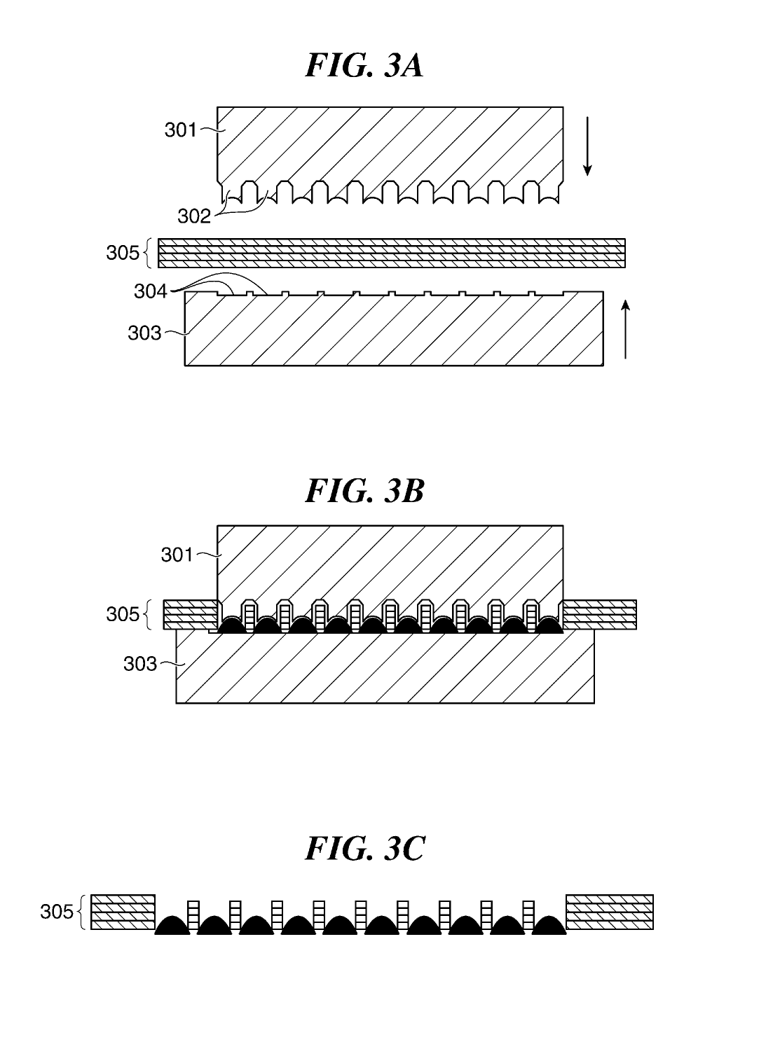

Next, the method of binding a sheet bundle by needleless binding by the post-processing section 115 appearing in FIG. 1 will be described with reference to FIGS. 3A to 3C. In the present embodiment, a description will be given of an example of needleless binding by the aforementioned method of pressure-bonding a sheet bundle into a bound state by applying pressure thereto from the direction of thickness thereof using protruding blades and recessed blades set on opposite sides of the sheet bundle.

FIG. 3A is a cross-sectional view of an upper die and a lower die in a state before a sheet bundle is bound, as viewed from a side surface of the sheet bundle.

The upper die 301 is used for applying pressure to the sheet bundle 305 by pressing the sheet bundle 305 from above. The upper die 301 is provided with a plurality of protrusions (protruding blades) 302. These protrusions 302 apply pressure to a plurality of portions of a sheet surface of the sheet bundle, whereby sheets of the sheet bundle 305 are pressure-bonded to each other such that they are not easily peeled off from each other.

The lower die 303 is used for applying pressure to the sheet bundle 305 by pressing the sheet bundle 305 from below. The lower die 303 is provided with a plurality of recesses (recessed blades) 304 associated with the protrusions 302 of the upper die 301. The plurality of recesses 304 receive the protrusions 302 of the upper die 301.

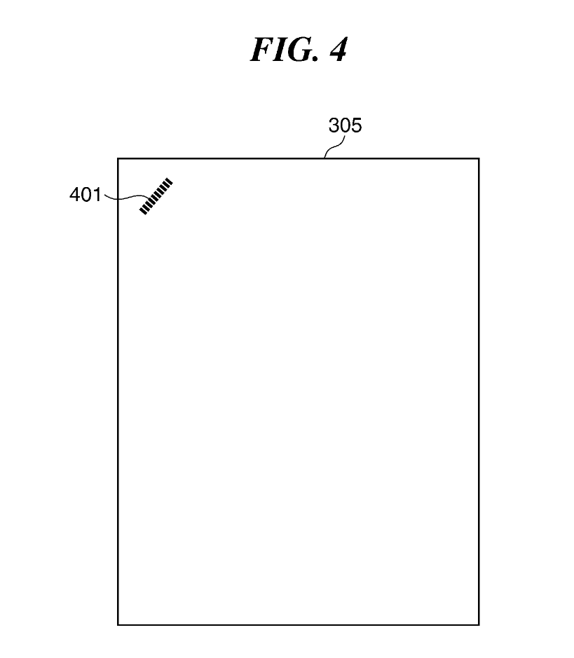

As shown in FIG. 3B, the sheet bundle 305 is bound by applying pressure to the sheet bundle 305 from above and below using the upper die 301 and the lower die 303. A cross-section of the bound sheet bundle 305 is shown in FIG. 3C. Further, the bound sheet bundle 305 as viewed from the sheet surface is shown in FIG. 4. A binding portion 401 is formed at a predetermined location of the sheet surface.

Next, a description will be given of the sheet information registered in the sheet information list. Note that each parameter, described hereinafter, of the sheet information is input from the console section 110 by a user.

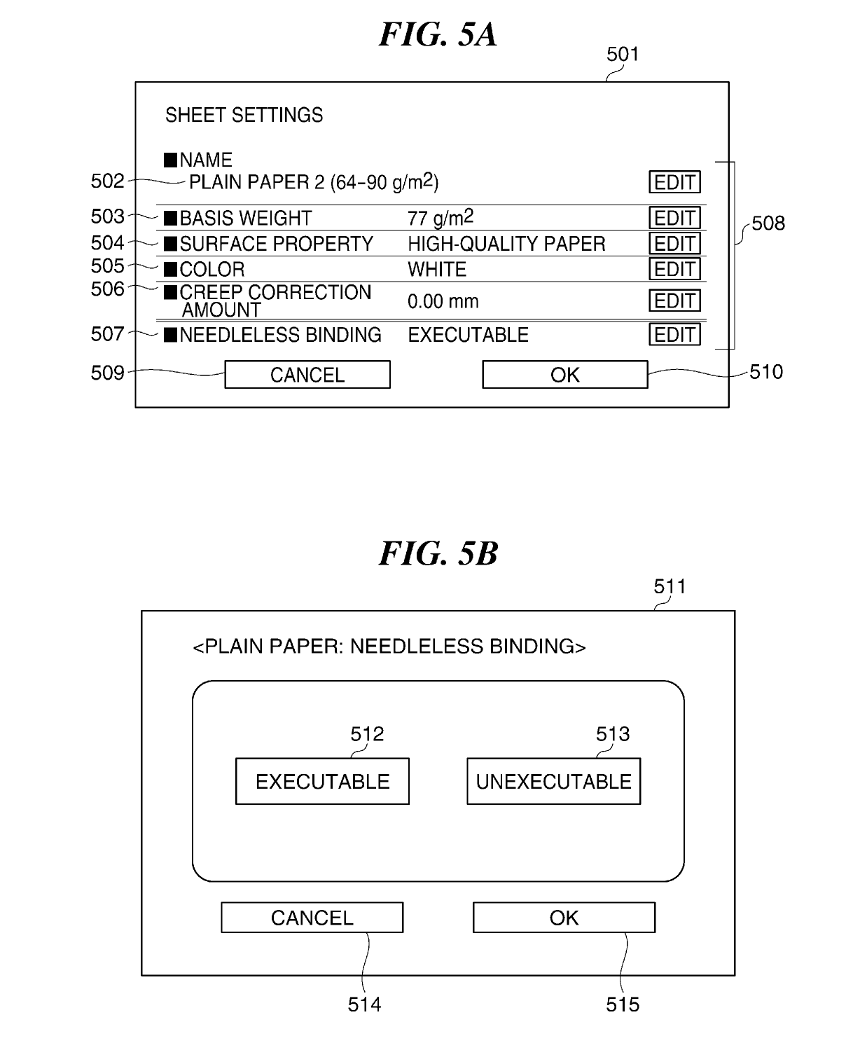

FIGS. 5A and 5B are diagrams of examples of setting screens displayed on the touch panel of the console section 110 of the image forming apparatus 101, in which FIG. 5A shows a sheet information-setting screen, and FIG. 5B shows a needleless binding executability information-setting screen.

Referring to FIG. 5A, the sheet information-setting screen 501 is a screen for registering sheet information in the sheet information list stored in the HDD 106. As for basic sheet information, it is stored in advance in the HDD 106 of the image forming apparatus 101, and is managed by the sheet information management section 203, and it is also possible for the user to add new sheet information to the basic sheet information from the sheet information-setting screen 501.

In the sheet information-setting screen 501, a name 502 indicates the sheet name of a sheet to be registered in the sheet information list 701. A basis weight 503 indicates the basis weight of the sheet to be registered in the sheet information list 701. A surface property 504 indicates the surface property of the sheet to be registered in the sheet information list 701. The term “surface property” refers to features of a sheet surface generated by the fact that the type of used fibers and the surface shape of a sheet vary with the sheet type. For example, high-quality paper, one-side coated paper, OHP film, and so forth can be set as the surface property.

A color 505 indicates the color of the sheet to be registered in the sheet information list 701. A creep correction amount 506 indicates the creep correction amount of the sheet to be registered in the sheet information list 701. The term “creep correction amount” refers to the amount of correction of displacement in image position between an outer sheet and an inner sheet, which is caused by bookbinding processing.

Needleless binding 507 indicates whether the sheet to be registered in the sheet information list 701 is needleless binding executable or needleless binding unexecutable. Since needleless binding is performed by application of pressure, as described hereinabove, binding processing sometimes fails depending on the surface property and basis weight of each sheet and the number of sheets of the sheet bundle. For example, coated paper and OHP film, which have smooth surface shapes, and a sheet having a large basis weight are not suitable for the above-described needleless binding. When registering a sheet unsuitable for needleless binding in the sheet information list 701, the needleless binding 507 is set to unexecutable.

When one of edit keys 508 associated with the respective items from the name 502 to the needleless binding 507 is selected, a dedicated screen for setting one of the items associated with the selected edit key 508 is displayed. For example, when one of the edit keys 508 associated with the needleless binding 507 is selected, a needleless binding executability-setting screen 511 appearing in FIG. 5B is displayed.

When a cancel key 509 is selected on the sheet information-setting screen 501, settings made via the sheet information-setting screen 501 are canceled, and the sheet information-setting screen 501 is closed. On the other hand, when an OK key 510 is selected, sheet information set via the sheet information-setting screen 501 is stored in the sheet information list 701 stored in the HDD 106, and the sheet information-setting screen 501 is closed.

Referring to FIG. 5B, the needleless binding executability-setting screen 511 is a screen for setting needleless binding executable or needleless binding unexecutable for each sheet registered on the sheet information-setting screen 501, i.e. for setting permission or inhibition of execution of needleless binding, on a sheet type-by-sheet type basis.

On the needleless binding executability-setting screen 511, when an executable key 512 is selected, the sheet information to be registered in the sheet information list 701 is set to needleless binding executable, and “executable” is displayed in a field of the needleless binding 507. When an unexecutable key 513 is selected, the sheet information to be registered in the sheet information list 701 is set to needleless binding unexecutable, and “unexecutable” is displayed in the field of the needleless binding 507. Further, when a cancel key 514 is selected, a setting made on the needleless binding executability-setting screen 511 is canceled, and the sheet information-setting screen 501 is closed. When an OK key 515 is selected, needleless binding executable or needleless binding unexecutable set on the needleless binding executability-setting screen 511 is reflected on the display of the needleless binding 507 on the sheet information-setting screen 501, and the sheet information-setting screen 501 is closed.

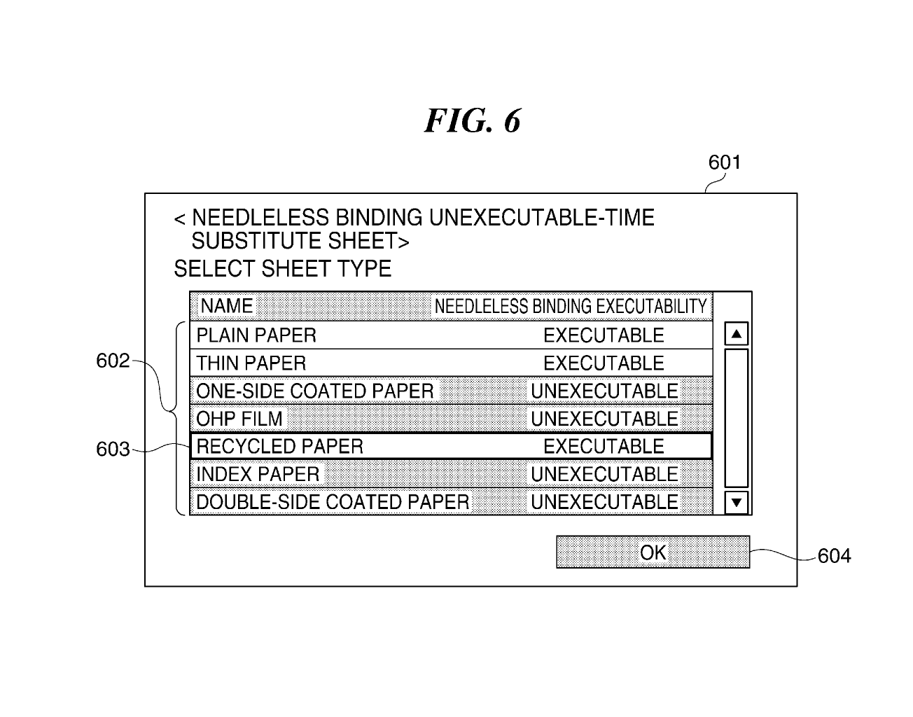

FIG. 6 is a diagram of an example of a substitute sheet-setting screen displayed on the touch panel of the console section 110 of the image forming apparatus 101.

A needleless binding unexecutable-time substitute sheet-setting screen 601 is a screen for setting a substitute sheet to be used in a case where sheet settings of print data include a needleless binding unexecutable sheet.

A candidate sheet list 602 is formed by listing sheet names in the sheet information list stored in advance in the HDD 106 (including a sheet name set on the sheet information-setting screen 501), and needleless binding executability information set in association with each sheet name (on a sheet type-by-sheet type basis).

In the candidate sheet list 602, it is possible to select a row of a sheet for which the needleless binding 507 is set to executable on the sheet information-setting screen 501, but it is made impossible to select a row of a sheet for which the needleless binding 507 is set to unexecutable on the sheet information-setting screen 501. For example, a box 603 indicates a row selected in the candidate sheet list 602.

In a case where print data includes a setting of needleless binding and also there is a page which is set to use a sheet determined to be needleless binding unexecutable, the PDL processor 202 replaces a sheet type set for the page with a sheet type displayed in the box 603.

In a case where an OK key 604 is selected on the needleless binding unexecutable-time substitute sheet-setting screen 601, a sheet selected thereon is stored in the HDD 106 of the image forming apparatus 101, as a substitute sheet to be used when needleless binding is unexecutable (at a needleless binding unexecutable time).

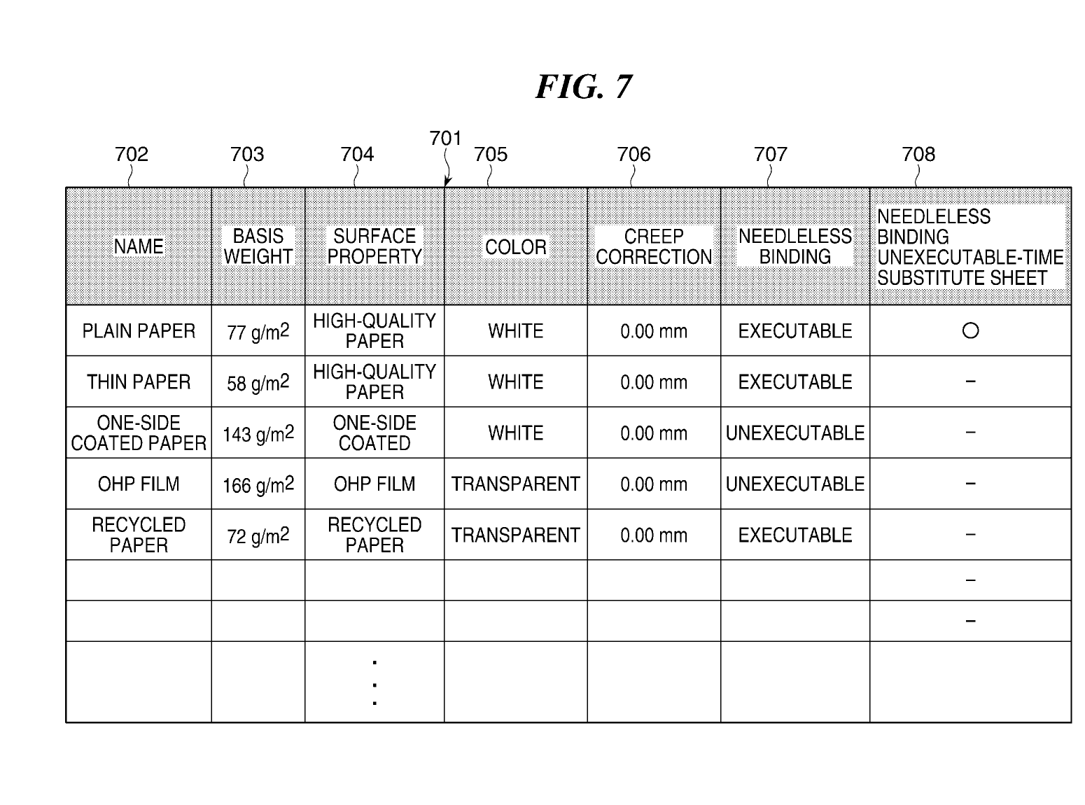

FIG. 7 is a diagram of an example of the sheet information list stored in the HDD 106 of the image forming apparatus 101.

Sheet information set on the sheet information-setting screen 501 and the needleless binding executability-setting screen 511 is registered in the sheet information list 701. The sheet information list 701 is managed by the sheet information management section 203. Contents of the sheet information list 701 can be edited on an edit screen (not shown) displayed on the console section 110.

Further, basic sheet information is stored in advance in the sheet information list 701, and the user can add sheet information of his or her own to the basic sheet information afterwards. The controller 102 causes the printing section 114 to perform optimum print processing on print data, using the sheet information registered in the sheet information list 701.

A name 702 indicates the name of a sheet. Note that general sheet names, such as plain paper and OHP film, are assumed to be registered in advance. Further, the name of a sheet registered by the user afterwards on the sheet information-setting screen 501 may be any suitable name insofar as it is not duplicate in the sheet information list 701.

A basis weight 703 indicates the basis weight of a sheet. In association with a sheet represented by the name 702, a value set for the basis weight 503 on the sheet information-setting screen 501 is registered.

A surface property 704 indicates the surface property of a sheet. In association with a sheet represented by the name 702, a value set for the surface property 504 on the sheet information-setting screen 501 is registered.

A color 705 indicates the color of a sheet. In association with a sheet represented by the name 702, a value set for the color 505 on the sheet information-setting screen 501 is registered.

A creep correction 706 indicates the creep correction amount of sheets to be applied in a case when sheets are book-bound. In association with a sheet represented by the name 702, a value set for the creep correction amount 506 on the sheet information-setting screen 501 is registered.

Needleless binding 707 indicates whether or not a sheet is needleless binding executable. In association with a sheet represented by the name 702, a value set for the needleless binding 507 on the sheet information-setting screen 501 is registered. The needleless binding executability determination section 204 refers to the needleless binding 707 in the sheet information list 701 via the sheet information management section 203, and determines whether or not the sheet is needleless binding executable.

A needleless binding unexecutable-time substitute sheet setting 708 indicates a setting for using a sheet indicated by the name 702 as a substitute, in a case where print data includes a setting of needleless binding and also there is a page which is set to a needleless binding unexecutable sheet. The needleless binding unexecutable-time substitute sheet setting 708 is set to a sheet selected on the needleless binding unexecutable-time substitute sheet-setting screen 601.

In the first embodiment, in a case where needleless binding is set and also a page is included which is set to a needleless binding unexecutable sheet, a sheet type of the page is replaced with a sheet type set in the needleless binding unexecutable-time substitute sheet setting 708 of the sheet information list 701.

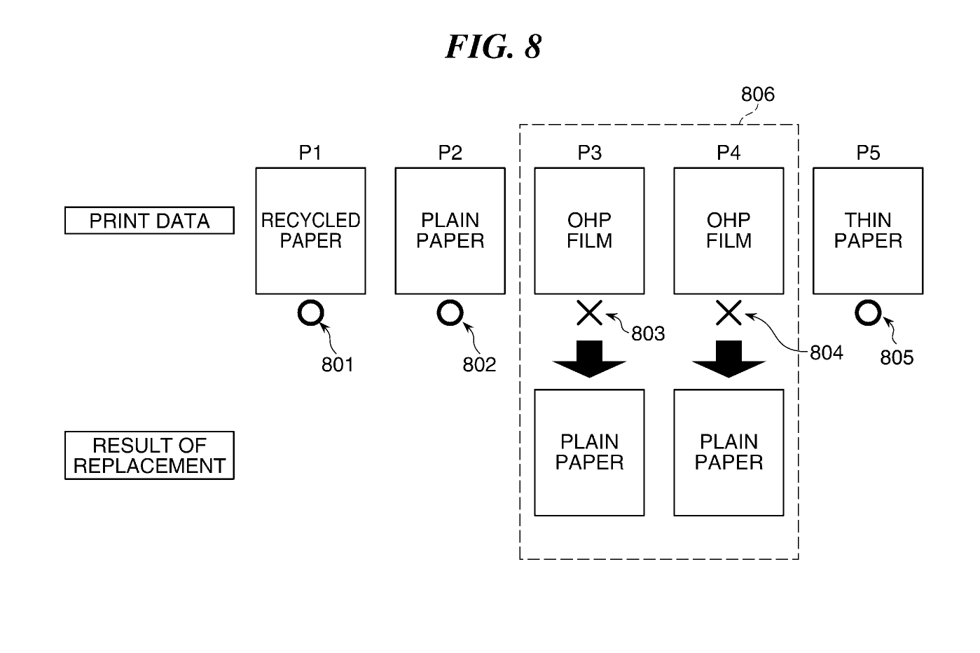

FIG. 8 is a diagram useful in explaining a method of performing replacement with the needleless binding unexecutable-time substitute sheet described above.

In the illustrated example, recycled paper, plain paper, OHP film, OHP film, and thin paper are set as sheet types for five respective pages (P1 to P5) of print data. Note that the number of pages and the sheet types are not limited to the illustrated example.

Needleless binding executability marks 801 to 805 set forth below the respective pages in FIG. 8 represent results of determination performed by the needleless binding executability determination section 204 as to whether or not a sheet type set for each of the pages is needleless binding executable. This determination is performed based on the sheet information registered in the sheet information list 701. Although in the present embodiment, it is assumed that unexecutable is registered in the needleless binding 707 associated with OHP film, and executable is registered in the needleless binding 707 associated with each of recycled paper, plain paper, and thin paper, it is to be understood different settings from the above may be employed.

Referring to FIG. 8, in a case where the needleless binding executability determination section 204 determines that pages P3 and P4 having OHP film set therefor are needleless binding unexecutable, a replacement process (enclosed by a broken line 806) is performed. The PDL processor 202 acquires a sheet type set in the print data, and inquires the needleless binding executability determination section 204 about whether or not the acquired sheet type is needleless binding executable. In a case where the needleless binding executability determination section 204 determines that the acquired sheet type is needleless binding unexecutable, the PDL processor 202 acquires a sheet type set in the needleless binding unexecutable-time substitute sheet setting 708 of the sheet information list 701 via the sheet information management section 203. Then, the sheet type set in the print data is replaced with the sheet type set in the needleless binding unexecutable-time substitute sheet setting 708. In the present embodiment, since plain paper is set in the needleless binding unexecutable-time substitute sheet setting 708 of the sheet information list 701, the sheet type OHP film set in the print data is replaced with plain paper.

After the above-described sheet type replacement process has been performed, the RIP 107 performs image generation, and then the print controller 206 instructs the printing section 114 to print a first page on recycled paper, second to fourth pages on plain paper, and a fifth page on thin paper. As a result, the post-processing section 115 performs needleless binding processing on sheets for all of which needleless binding based on the pressure application method can be performed, and hence it is possible to prevent failure of the needleless binding.

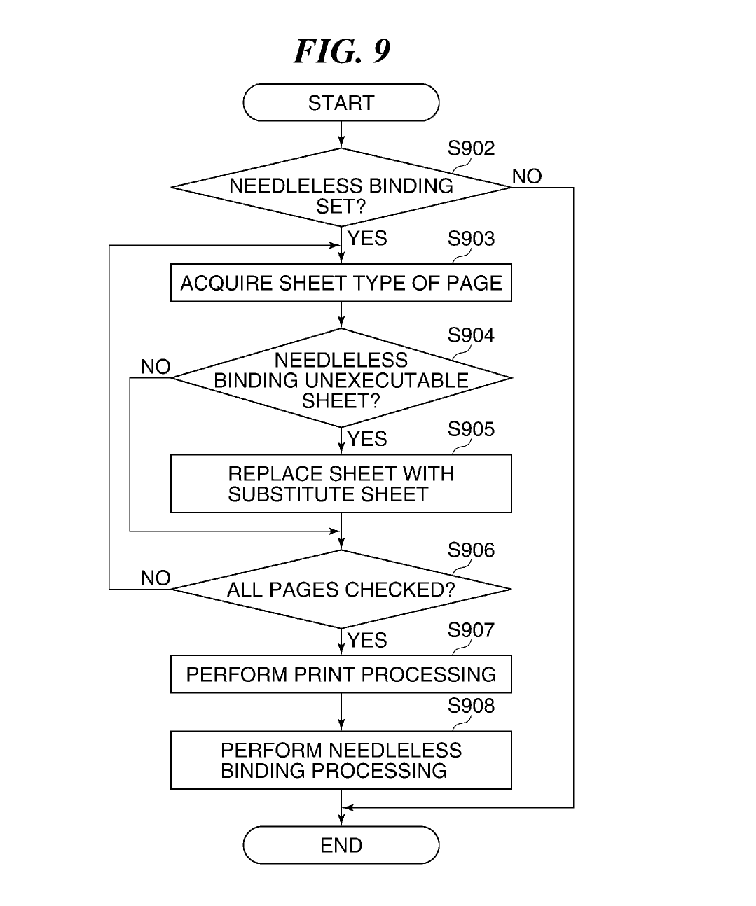

FIG. 9 is a flowchart of the sheet type replacement process described above with reference to FIG. 8. S902 to S908 in FIG. 9 denote respective steps of the sheet type replacement process. The present process is realized by the CPU 103 which executes a control program loaded from the HDD 106 into the RAM 104. Note that steps S903 to S906 appearing in FIG. 9 are loop processing performed on each page of the print data. This loop processing is sequentially performed on all pages, in an order starting from a leading page.

In a step S902, the PDL processor 202 determines based on print settings of the print data whether or not the print settings include needleless binding. If the print settings include needleless binding, the process proceeds to the step S903. On the other hand, if the print settings do not include needleless binding, the present process is immediately terminated, and thereafter, print processing and post-processing are performed based on the print settings of the print data.

In the step S903, the PDL processor 202 acquires a sheet type set for a target page of the print data, and inquires the needleless binding executability determination section 204 about needleless binding executability of the acquired sheet type.

In a step S904, the needleless binding executability determination section 204 refers to the sheet information list 701 via the sheet information management section 203, and determines whether or not the sheet type acquired in the step S903 is needleless binding unexecutable. If the sheet type acquired in the step S903 is needleless binding unexecutable, the process proceeds to a step S905. On the other hand, if the sheet type acquired in the step S903 is needleless binding executable, the process proceeds to the step S906.

In the step S905, the PDL processor 202 acquires a sheet type set in the needleless binding unexecutable-time substitute sheet setting 708 of the sheet information list 701, and replaces the sheet type which has been determined to be needleless binding unexecutable in the step S904, with the acquired sheet type.

In the step S906, the PDL processor 202 determines whether or not the loop processing on all the pages of the print data has been completed. If the loop processing has not been completed, the process returns to the step S903, whereas if the loop processing has been completed, the process proceeds to the step S907.

In the step S907, the print controller 206 gives a print instruction of the print data generated by the RIP 107 to the printing section 114. The sheet type set by the replacement in the step S905 is reflected on sheets to be used by the printing section 114.

In the step S908, the post-processing section 115 performs post-processing on a bundle of sheets printed in the step S907 according to the instruction from the print controller 206. For example, when the settings of the print data include needleless binding, needleless binding processing is performed. All sheets that have been determined, by the needleless binding executability determination section 204, to be needleless binding unexecutable, have been replaced with sheets of a sheet type which is needleless binding executable, through the replacement process in the step S905. This enables the post-processing section 115 to prevent failure of needleless binding and thereby provide printed matter as desired or substantially as desired by the user.

Next, a description will be given of a second embodiment of the present invention. In the second embodiment, in a case where needleless binding is set and also a page is included which is set to a needleless binding unexecutable sheet, a sheet type set for the page is replaced with a sheet type set for a leading page, the immediately preceding page, or the immediately following page of the print data.

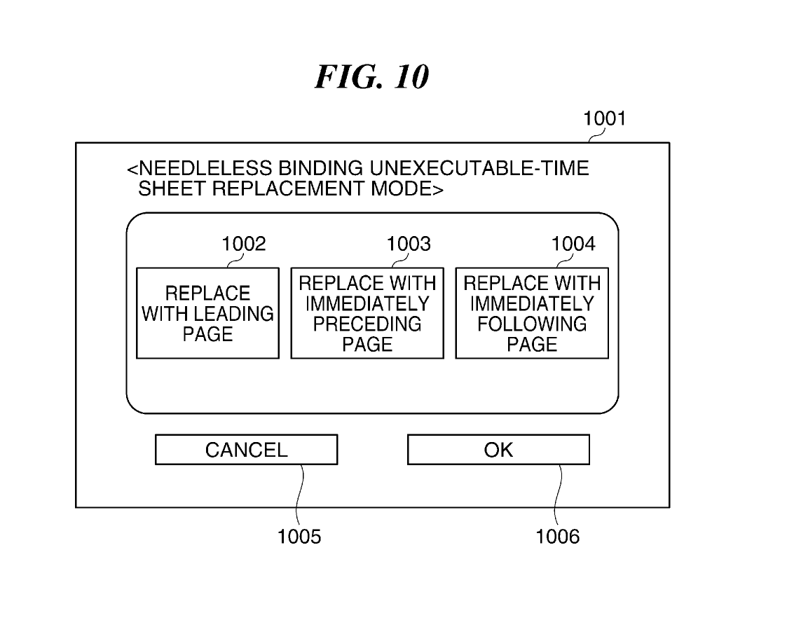

FIG. 10 is a diagram of an example of a needleless binding unexecutable-time sheet replacement mode-setting screen displayed on the touch panel of the console section 110 of the image forming apparatus 101.

On the setting screen appearing in FIG. 10, in a case where a replace-with-leading page key 1002 is selected, a sheet type of which has been determined, by the needleless binding executability determination section 204, to be needleless binding unexecutable, is replaced with a sheet type of a leading page.

On the other hand, when a replace-with-immediately preceding page key 1003 is selected, the sheet type which has been determined, by the needleless binding executability determination section 204, to be needleless binding unexecutable, is replaced with a sheet type of the immediately preceding page.

Further, when a replace-with-immediately following page key 1004 is selected, the sheet type which has been determined, by the needleless binding executability determination section 204, to be needleless binding unexecutable, is replaced with a sheet type of the immediately following page.

When an OK key 1006 is selected after one of the replacement keys 1002 to 1004 has been selected, a sheet replacement mode set on the needleless binding unexecutable-time sheet replacement mode-setting screen, denoted by reference numeral 1001, is stored in the HDD 106 of the image forming apparatus 101, and the needleless binding unexecutable-time sheet replacement mode-setting screen 1001 is closed. On the other hand, when a cancel key 1005 is selected, the sheet replacement mode set on the needleless binding unexecutable-time sheet replacement mode-setting screen 1001 is canceled, and the needleless binding unexecutable-time sheet replacement mode-setting screen 1001 is closed.

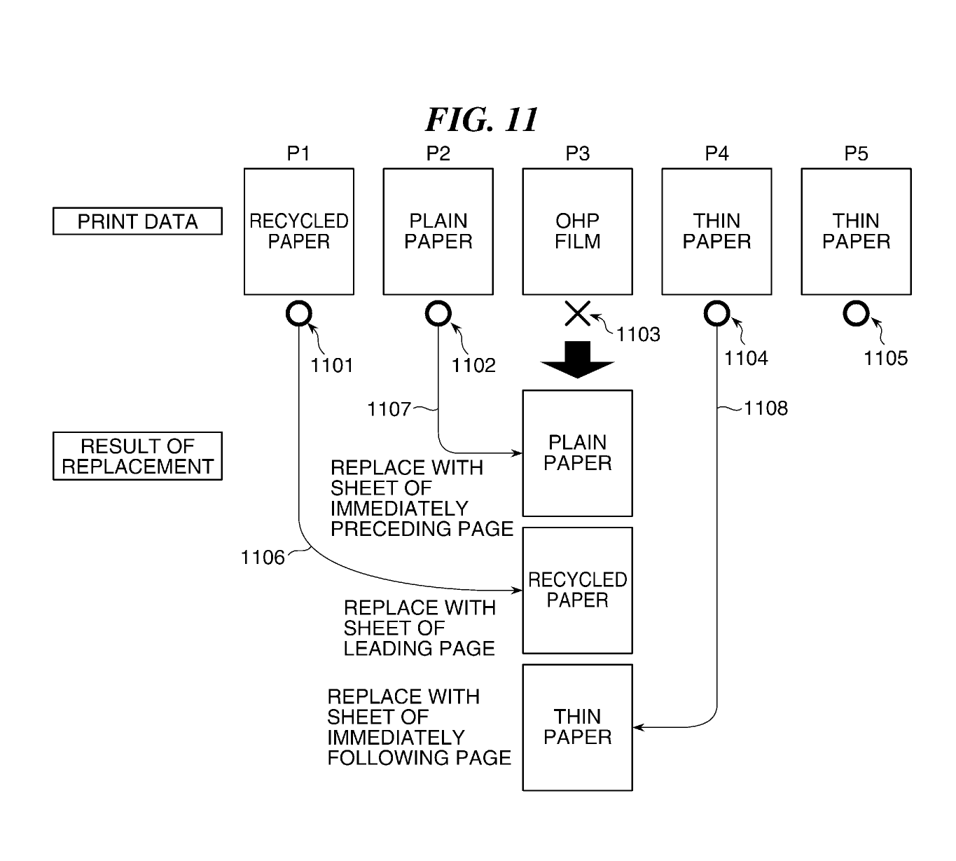

FIG. 11 is a diagram useful in explaining the outline of a method of performing replacement with a needleless binding unexecutable-time substitute sheet, according to the second embodiment.

In the illustrated example, recycled paper, plain paper, OHP film, thin paper, and thin paper are set as sheet types for five respective pages (P1 to P5) of print data. Note that the number of pages and the sheet types are not limited to the illustrated example.

Needleless binding executability marks 1101 to 1105 set forth below the respective pages in FIG. 11 represent results of determination by the needleless binding executability determination section 204 as to whether or not a sheet type set for each of the pages is needleless binding executable. This determination is performed based on the sheet information registered in the sheet information list 701. Although in the present embodiment, it is assumed that unexecutable is registered in the needleless binding 707 associated with OHP film, and executable is registered in the needleless binding 707 associated with each of recycled paper, plain paper, and thin paper, it is to be understood different settings from the above may be employed.

Referring to FIG. 11, in a case where the needleless binding executability determination section 204 determines that a page P3 having OHP film set therefor is needleless binding unexecutable, the replacement process is performed. For example, when replacement with a sheet type of the leading page has been set on the needleless binding unexecutable-time sheet replacement mode-setting screen 1001, the OHP film of the page P3 is replaced with recycled paper set for the leading page (indicated by an arrow 1106). Note that in a case where a sheet set for the leading page is a sheet determined to be needleless binding unexecutable, the sheet type of the page P3 is replaced with a sheet type set in the needleless binding unexecutable-time substitute sheet setting 708 of the sheet information list 701.

Further, when replacement with a sheet type of the immediately preceding page has been set on the needleless binding unexecutable-time sheet replacement mode-setting screen 1001, the OHP film of the page P3 is replaced with plain paper set for the page immediately preceding the page P3 (indicated by an arrow 1107). Note that in a case where a needleless binding unexecutable sheet has been set for the leading page of print data which does not have the immediately preceding page, the sheet type of the page P3 is replaced with the sheet type set in the needleless binding unexecutable-time substitute sheet setting 708 of the sheet information list 701.

Further, in a case where replacement with a sheet type of the immediately following page has been set on the needleless binding unexecutable-time sheet replacement mode-setting screen 1001, the OHP film of the page P3 is replaced with thin paper set for the page immediately following the page P3 (indicated by an arrow 1108). Note that a needleless binding unexecutable sheet has been set for the last page of print data which does not have the immediately following page, the sheet type of the page P3 is replaced with the sheet type set in the needleless binding unexecutable-time substitute sheet setting 708 of the sheet information list 701.

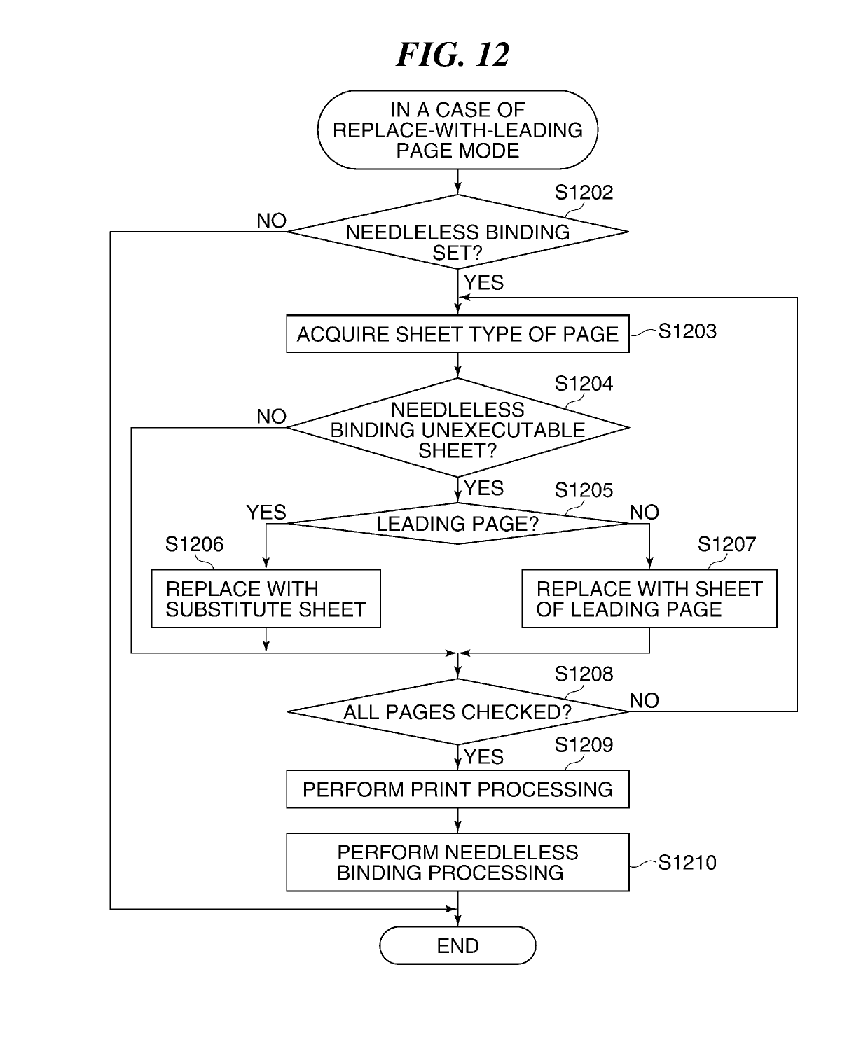

Next, with reference to FIGS. 12 to 14, a description will be given of a replacement process based on the sheet type replacement method described with reference to FIG. 11.

FIG. 12 is a flowchart of a replacement process performed when replacement with a sheet type of the leading page has been set on the needleless binding unexecutable-time sheet replacement mode-setting screen 1001. S1202 to S1210 appearing in FIG. 12 denote respective steps of the replacement process. The present process is realized by the CPU 103 which executes a control program loaded from the HDD 106 into the RAM 104. Note that steps S1203 to S1208 appearing in FIG. 12 are loop processing performed on each page of the print data. This loop processing is sequentially performed on all pages, in an order starting from a leading page.

In the step S1202, the PDL processor 202 determines based the on print settings of the print data whether or not needleless binding has been set. If needleless binding has been set, the process proceeds to the step S1203. On the other hand, if needleless binding has not been set, the present process is immediately terminated, and thereafter, print processing and post-processing are performed based on the print settings of the print data.

In the step S1203, the PDL processor 202 acquires a sheet type set for a target page of the print data, and inquires the needleless binding executability determination section 204 about needleless binding executability of the acquired sheet type.

In a step S1204, the needleless binding executability determination section 204 refers to the sheet information list 701 via the sheet information management section 203, and determines whether or not the sheet type acquired in the step S1203 is needleless binding unexecutable. If the sheet type acquired in the step S1203 is needleless binding unexecutable, the process proceeds to a step S1205. On the other hand, if the sheet type acquired in the step S1203 is needleless binding executable, the process proceeds to the step S1208.

In the step S1205, the PDL processor 202 determines whether or not the target page is the leading page of the print data. If the target page is the leading page of the print data, the process proceeds to a step S1206, whereas if not, the process proceeds to a step S1207. Since the present process is a process for replacing a needleless binding unexecutable sheet type with the sheet type of the leading page, a sheet type that is needleless binding executable is necessarily required to be used for the leading page. This requires the leading page to be subjected to different processing from processing on a second page et seq.

In the step S1206, the PDL processor 202 acquires a sheet type from the needleless binding unexecutable-time substitute sheet setting 708 of the sheet information list 701, and replaces the sheet type that has been determined to be needleless binding unexecutable in the step S1204 and is set for the leading page, with the acquired sheet type.

In the step S1207, the PDL processor 202 replaces the sheet type that has been determined in the step S1204 to be needleless binding unexecutable, with the sheet type of the leading page. The sheet type of the leading page of the print data is replaced, if required, in the step 1206 with a sheet type that is needleless binding executable, and hence the sheet type of the page which is replaced in the step S1207 is necessarily replaced with a sheet type that is needleless binding executable.

In the step S1208, the PDL processor 202 determines whether or not the loop processing on all the pages of the print data has been completed. If the loop processing has not been completed, the process returns to the step S1203, whereas if the loop processing has been completed, the process proceeds to a step S1209.

In the step S1209, the print controller 206 gives a print instruction for printing print data generated by the RIP 107 to the printing section 114. The sheet type set by the replacement in the step S1206 or S1207 is reflected on sheets to be used by the printing section 114.

In the step S1210, the post-processing section 115 performs post-processing on a bundle of sheets printed in the step S1209 according to the instruction from the print controller 206. For example, in a case where needleless binding is set in the print data, needleless binding processing is performed. All sheets that have been determined, by the needleless binding executability determination section 204, to be needleless binding unexecutable, have been replaced with sheets of a sheet type which is needleless binding executable, through the replacement process in the step S1206 or S1207. Therefore, the post-processing section 115 is capable of preventing failure of needleless binding to provide printed matter as desired or substantially as desired by the user.

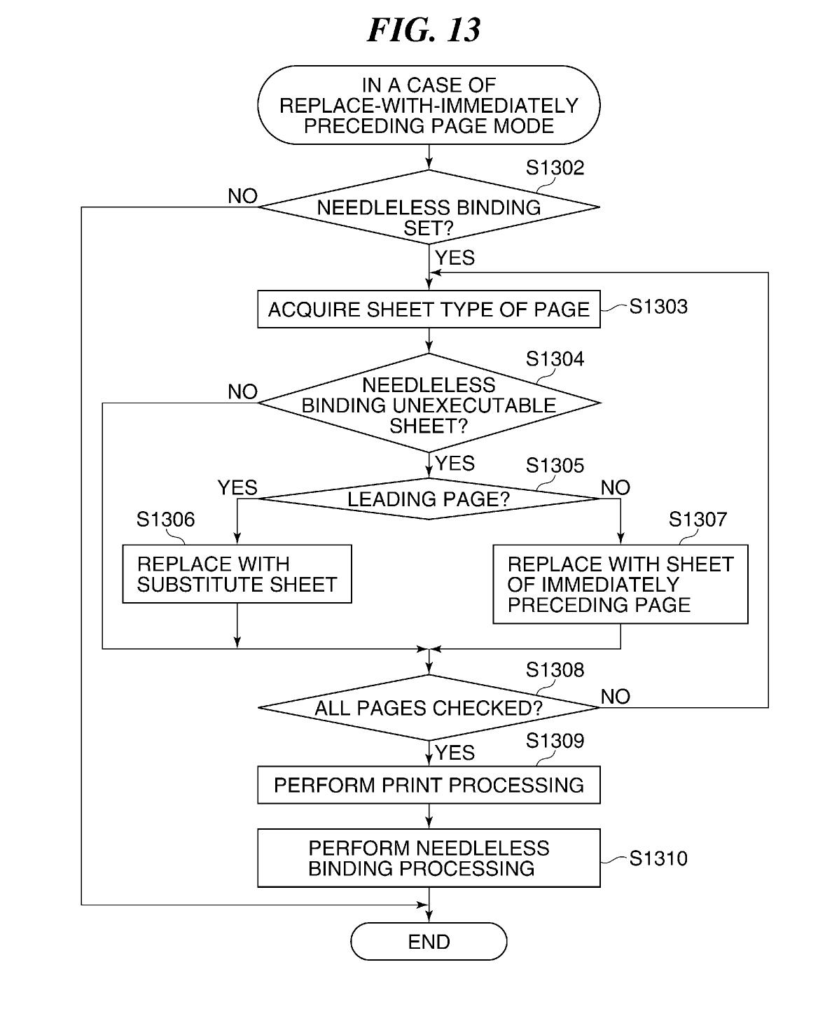

FIG. 13 is a flowchart of a replacement process performed when replacement with a sheet type of the immediately preceding page has been set on the needleless binding unexecutable-time sheet replacement mode-setting screen 1001. S1302 to S1310 appearing in FIG. 13 denote respective steps of the replacement process. The present process is realized by the CPU 103 which executes a control program loaded from the HDD 106 into the RAM 104. Note that steps S1303 to S1308 appearing in FIG. 13 are loop processing performed on each page of the print data. This loop processing is sequentially performed on all pages, in an order starting from the leading page.

In the step S1302, the PDL processor 202 determines based on the print settings of the print data whether or not needleless binding has been set. If needleless binding has been set, the process proceeds to the step S1303. On the other hand, if needleless binding has not been set, the present process is immediately terminated, and thereafter, print processing and post-processing are executed based on the print settings of the print data.

In the step S1303, the PDL processor 202 acquires a sheet type set for a target page of the print data, and inquires the needleless binding executability determination section 204 about needleless binding executability of the acquired sheet type.

In the step S1304, the needleless binding executability determination section 204 refers to the sheet information list 701 via the sheet information management section 203, and determines whether or not the sheet type acquired in the step S1303 is needleless binding unexecutable. If the sheet type acquired in the step S1303 is needleless binding unexecutable, the process proceeds to a step S1305. On the other hand, if the sheet type acquired in the step S1303 is needleless binding executable, the process proceeds to the step S1308.

In the step S1305, the PDL processor 202 determines whether or not the target page is the leading page of the print data. If the target page is the leading page, the process proceeds to a step S1306, whereas if not, the process proceeds to a step S1307. Since the present process is a process for replacing a needleless binding unexecutable sheet type with the sheet type of the immediately preceding page, if the target page is the leading page of the print data, there is no page corresponding to the immediately preceding page. This requires the leading page to be subjected to different processing from processing on a second page et seq.

In the step S1306, the PDL processor 202 acquires a sheet type set in the needleless binding unexecutable-time substitute sheet setting 708 of the sheet information list 701, and replaces the sheet type set for the leading page with the acquired sheet type.

In the step S1307, the PDL processor 202 replaces the sheet type that has been determined in the step S1304 to be needleless binding unexecutable, with the sheet type of the immediately preceding page. The sheet type of the leading page, as a reference, of the print data is replaced, if required, in the step S1306 with a sheet type that is needleless binding executable, and hence the sheet type of the page which is replaced in the step S1307 is necessarily replaced with a sheet type that is needleless binding executable.

In the step S1308, the PDL processor 202 determines whether or not the loop processing on all pages of the print data has been completed. If the loop processing has not been completed, the process returns to the step S1303, whereas if the loop processing has been completed, the process proceeds to a step S1309.

In the step S1309, the print controller 206 gives a print instruction for printing print data generated by the RIP 107 to the printing section 114. The sheet type set by the replacement in the step S1306 or S1307 is reflected on sheets to be used by the printing section 114.

In the step S1310, the post-processing section 115 performs post-processing on a bundle of sheets printed in the step S1309 according to the instruction from the print controller 206. For example, in a case where needleless binding is set in the print data, needleless binding processing is performed. All sheets that have been determined, by the needleless binding executability determination section 204, to be needleless binding unexecutable, have been replaced with sheets of a sheet type which is needleless binding executable, through the replacement process in the step S1206 or S1207. Therefore, the post-processing section 115 is capable of preventing failure of needleless binding to provide printed matter as desired or substantially as desired by the user.

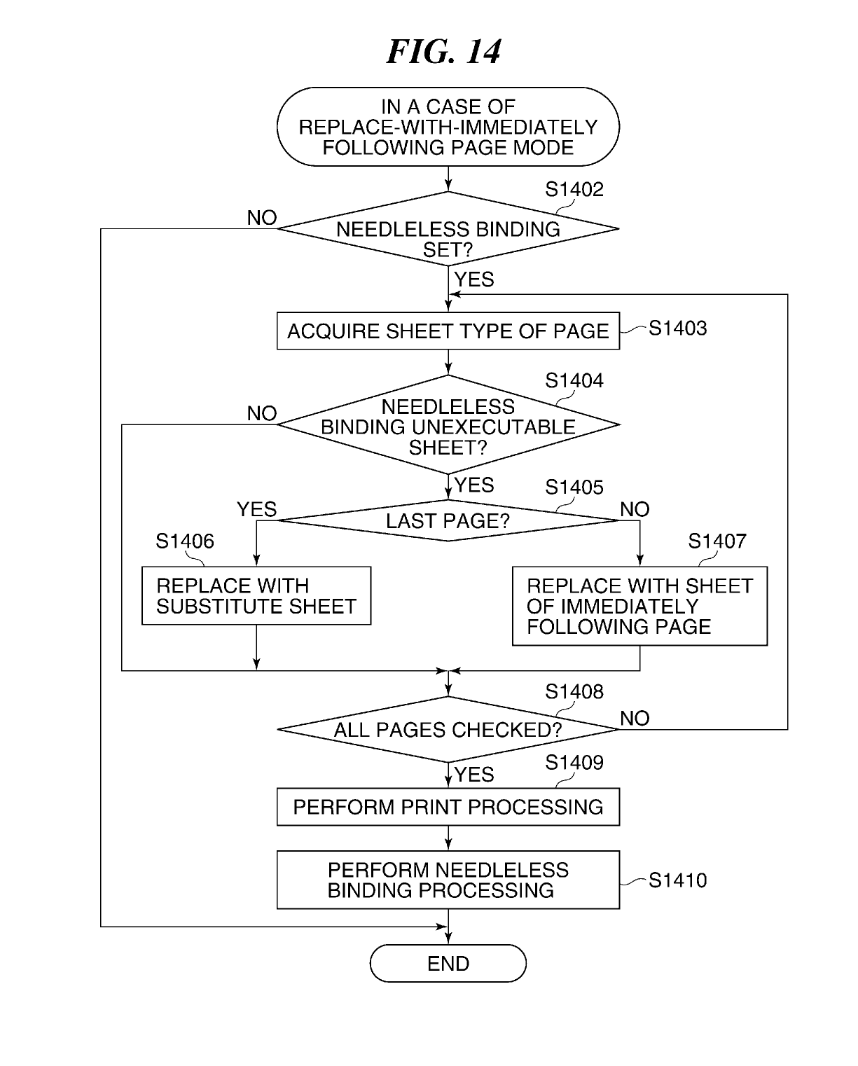

FIG. 14 is a flowchart of a replacement process performed in a case where replacement with a sheet of the immediately following page has been set on the needleless binding unexecutable-time sheet replacement mode-setting screen 1001. S1402 to S1410 appearing in FIG. 14 denote respective steps of the replacement process. The present process is realized by the CPU 103 which executes a control program loaded from the HDD 106 into the RAM 104. Note that steps S1403 to S1408 appearing in FIG. 14 are loop processing performed on each page of the print data. Particularly, the loop processing is distinguished from the loop processing in FIGS. 10, 12, and 13 in that it is sequentially performed on all pages, in an order starting from the last page of the print data.

In the step S1402, the PDL processor 202 determines based on the print settings of the print data whether or not needleless binding has been set. If needleless binding has been set, the process proceeds to the step S1403. On the other hand, if needleless binding has not been set, the present process is immediately terminated, and thereafter, print processing and post-processing are performed based on the print settings of the print data.

In the step S1403, the PDL processor 202 acquires a sheet type set for a target page of the print data, and inquires the needleless binding executability determination section 204 about needleless binding executability of the acquired sheet type.

In a step S1404, the needleless binding executability determination section 204 refers to the sheet information list 701 via the sheet information management section 203, and determines whether or not the sheet type acquired in the step S1403 is needleless binding unexecutable. If the sheet type acquired in the step S1403 is needleless binding unexecutable, the process proceeds to a step S1405. On the other hand, if the sheet type acquired in the step S1403 is needleless binding executable, the process proceeds to the step S1408.

In the step S1405, the PDL processor 202 determines whether or not the target page is the last page of the print data. If the target page is the last page, the process proceeds to a step S1406, whereas if not, the process proceeds to a step S1407. Since the present process is a process for replacing a needleless binding unexecutable sheet type with the sheet type of the immediately following page, if the target page is the last page of the print data, there is no page immediately following the same. This requires the last page to be subjected to different processing from processing on pages other than the last page.

In the step S1406, the PDL processor 202 acquires a sheet type set in the needleless binding unexecutable-time substitute sheet setting 708 of the sheet information list 701, and replaces a sheet type set for the last page with the acquired sheet type.

In the step S1407, the PDL processor 202 replaces the sheet type that has been determined in the step S1404 to be needleless binding unexecutable, with the sheet type of the immediately following page. The sheet type of the last page of the print data is replaced, if required, in the step S1406 with a sheet type that is needleless binding executable, and hence the sheet type of the page which is replaced in the step S1407 is necessarily replaced with a sheet type that is needleless binding executable. Note that in the present process, the pages are sequentially processed from the last page toward the leading page, so that when the target page is a page P3, for example, the immediately following page is a page P4.

In the step S1408, the PDL processor 202 determines whether or not the loop processing on all pages of the print data has been completed. If the loop processing has not been completed, the process returns to the step S1403, whereas if the loop processing has been completed, the process proceeds to a step S1409.

In the step S1409, the print controller 206 gives a print instruction for printing print data generated by the RIP 107 to the printing section 114. The sheet type set by the replacement in the step S1406 or S1407 is reflected on sheets to be used by the printing section 114.

In the step S1410, the post-processing section 115 performs post-processing on a bundle of sheets printed in the step S1409 according to the instruction from the print controller 206. For example, when needleless binding is set in the print data, needleless binding processing is performed. All sheets that have been determined, by the needleless binding executability determination section 204, to be needleless binding unexecutable, have been replaced with sheets of a sheet type which is needleless binding executable, through the replacement process in the step S1406 or S1407. Therefore, the post-processing section 115 is capable of preventing failure of needleless binding to provide printed matter as desired or substantially as desired by the user.

Next, a description will be given of a third embodiment of the present invention. In the third embodiment, in a case where a print job is received which is set to needleless binding and also includes a page which is set to a needleless binding unexecutable sheet, in a state in which execution of automatic replacement has been selected by the user on a needleless binding unexecutable-time automatic sheet type replacement-setting screen 1501, a sheet type of the page is replaced with a sheet type set in the needleless binding unexecutable-time substitute sheet setting 708 of the sheet information list 701.

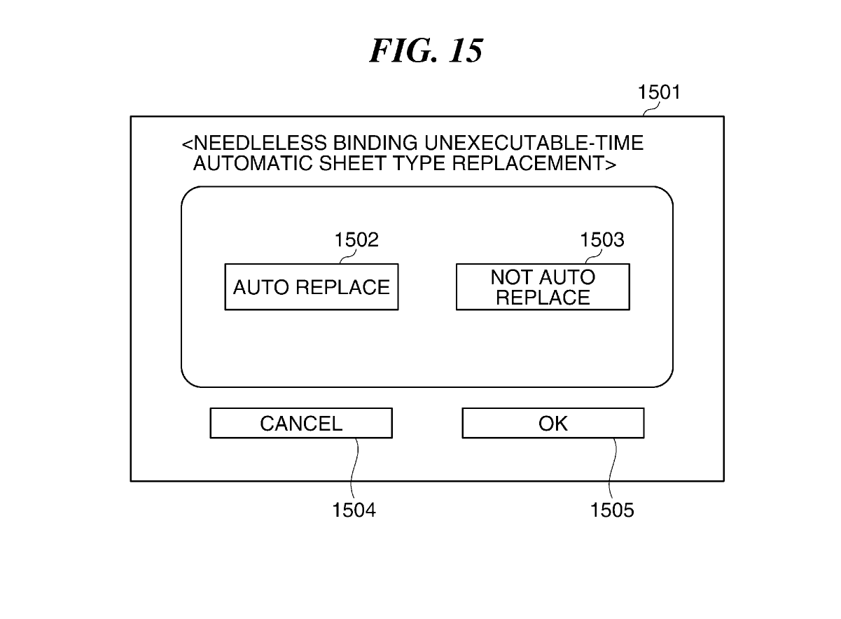

FIG. 15 is a diagram of an example of the needleless binding unexecutable-time automatic sheet type replacement-setting screen 1501 displayed on the touch panel of the console section 110 of the image forming apparatus 101.

On the needleless binding unexecutable-time automatic sheet type replacement-setting screen 1501 shown in FIG. 15, in a case where an auto-replace key 1502 is selected, a sheet type which is set in received print data and is determined, by the needleless binding executability determination section 204, to be needleless binding unexecutable is automatically replaced with a sheet type set in the needleless binding unexecutable-time substitute sheet setting 708 of the sheet information list 701.

On the other hand, in a case where a not-auto-replace key 1503 is selected, neither the needleless binding executability determination by the needleless binding executability determination section 204 nor the sheet type replacement is performed.

When an OK key 1505 is selected after selecting one of the auto-replace key 1502 and the not-auto-replace key 1503, information set on the needleless binding unexecutable-time automatic sheet type replacement-setting screen 1501 as to whether or not to perform automatic sheet type replacement is stored in the HDD 106 of the image forming apparatus 101, and the needleless binding unexecutable-time automatic sheet type replacement-setting screen 1501 is closed. On the other hand, when a cancel key 1504 is selected, a setting made on the needleless binding unexecutable-time automatic sheet type replacement-setting screen 1501 as to whether or not to perform automatic sheet type replacement is canceled, and the needleless binding unexecutable-time automatic sheet type replacement-setting screen 1501 is closed.

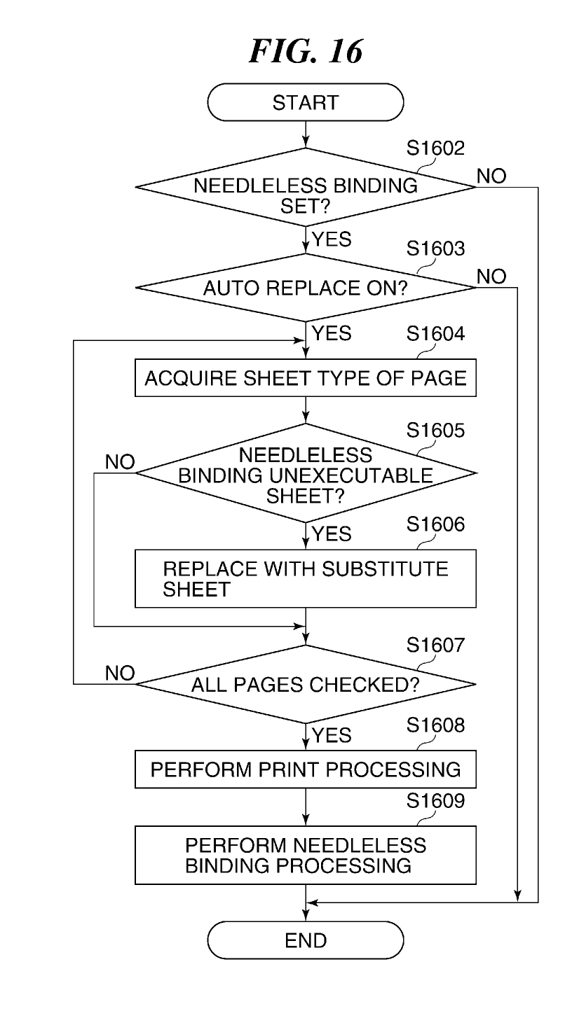

FIG. 16 is a flowchart of an automatic sheet type replacement process performed when it is possible to select whether or not to perform automatic sheet type replacement described with reference to FIG. 15. S1602 to S1609 in FIG. 16 denote respective steps of the process. The present process is realized by the CPU 103 which executes a control program loaded from the HDD 106 into the RAM 104. Note that steps S1604 to S1607 appearing in FIG. 16 are loop processing performed on each page of the print data. This loop processing is sequentially performed on all pages, in an order starting from the leading page of the print data.

In the step S1602, the PDL processor 202 determines based on the print settings of the print data whether or not needleless binding has been set. If needleless binding has been set, the process proceeds to a step S1603. On the other hand, if needleless binding has not been set, the present process is immediately terminated, and thereafter, print processing is performed based on the print settings of the print data. In this case, even if a sheet type designated for at least some of pages is one determined to be needleless binding unexecutable, print processing using the designated sheet type is performed without performing sheet type replacement, and printed sheets are discharged without performing needleless binding.

In the step S1603, it is determined whether or not a setting for performing automatic sheet type replacement has been made by the user on the needleless binding unexecutable-time automatic sheet type replacement-setting screen 1501. If the setting for performing automatic sheet type replacement has been made, the process proceeds to the step S1604. On the other hand, if the setting for performing automatic sheet type replacement has not been made, the present process is immediately terminated, and thereafter, print processing and post-processing are performed based on the print settings of the print data.

In the step S1604, the PDL processor 202 acquires a sheet type set for a target page of the print data, and inquires the needleless binding executability determination section 204 about needleless binding executability of the acquired sheet type.

In a step S1605, the needleless binding executability determination section 204 refers to the sheet information list 701 via the sheet information management section 203, and determines whether or not the sheet type acquired in the step S1604 is needleless binding unexecutable. If the sheet type acquired in the step S1604 is needleless binding unexecutable, the process proceeds to a step S1606. On the other hand, if the sheet type acquired in the step S1604 is needleless binding executable, the process proceeds to the step S1607.

In the step S1606, the PDL processor 202 acquires a sheet type from the needleless binding unexecutable-time substitute sheet setting 708 of the sheet information list 701, and replaces the sheet type which has been determined in the step S1605 to be needleless binding unexecutable with the acquired sheet type.

In the step S1607, the PDL processor 202 determines whether or not the loop processing on all pages of the print data has been completed. If the loop processing has not been completed, the process returns to the step S1604, whereas if the loop processing has been completed, the process proceeds to a step S1608.

In the step S1608, the print controller 206 gives a print instruction for printing print data generated by the RIP 107 to the printing section 114. The sheet type set by the replacement in the step S1606 is reflected on sheets to be used by the printing section 114.

In the step S1609, the post-processing section 115 performs post-processing on a bundle of sheets printed in the step S1608 according to the instruction from the print controller 206. For example, when needleless binding is set in the print data, needleless binding processing is performed. At this time, if the setting for performing automatic replacement of the sheet type have been made, all sheets that have been determined, by the needleless binding executability determination section 204, to be needleless binding unexecutable, have been replaced with sheets of a sheet type which is needleless binding executable, through the replacement process in the step S1606. Therefore, the post-processing section 115 is capable of preventing failure of needleless binding to provide printed matter as desired or substantially as desired by the user.

Next, a description will be given of a fourth embodiment of the present invention. In the fourth embodiment, in a case where a print job is received which includes a page which is set to needleless binding and also which is set to a needleless binding unexecutable sheet, a needleless binding unexecutable sheet type replacement confirmation screen is displayed to prompt the user to confirm whether to replace the sheet type of the page with a sheet type set in the needleless binding unexecutable-time substitute sheet setting 708 of the sheet information list 701.

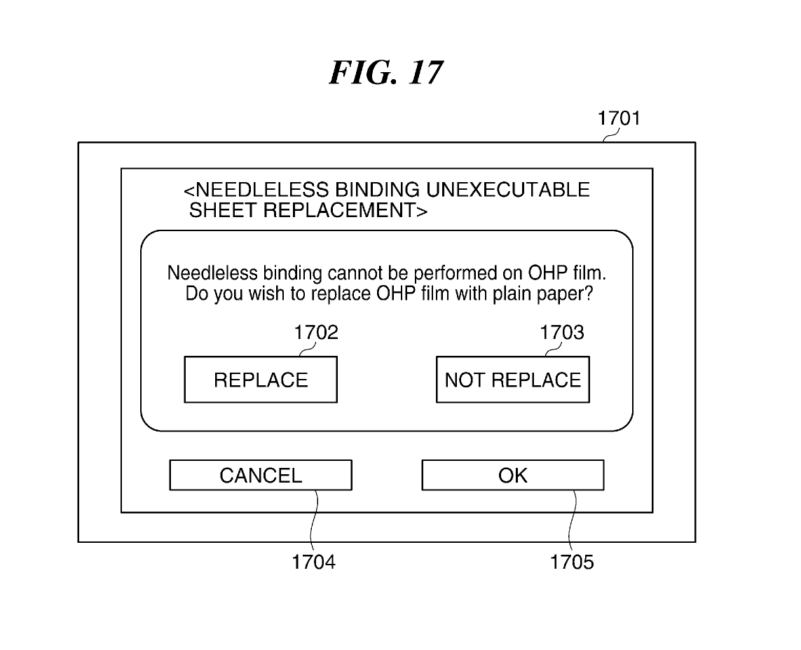

FIG. 17 is a diagram of an example of the needleless binding unexecutable sheet type replacement confirmation screen 1701 displayed on the touch panel of the console section 110 of the image forming apparatus 101 according to the fourth embodiment.

The needleless binding unexecutable sheet type replacement confirmation screen 1701 shown in FIG. 17 is displayed when a page is detected which is set to needleless binding and also which is set to a needleless binding unexecutable sheet.

In a case where a replace key 1702 is selected, a sheet type which has been determined by the needleless binding executability determination section 204 to be needleless binding unexecutable is replaced with a sheet type set in the needleless binding unexecutable-time substitute sheet setting 708 of the sheet information list 701. On the other hand, in a case where a not-replace key 1703 is selected, the sheet type replacement process is not performed.

Where an OK key 1705 is selected after one of the replace key 1702 and the not-replace key 1703 has been selected, a sheet type which has been determined by the needleless binding executability determination section 204 to be needleless binding unexecutable is replaced with a sheet type set in the needleless binding unexecutable-time substitute sheet setting 708 of the sheet information list 701, and the needleless binding unexecutable sheet type replacement confirmation screen 1701 is closed. On the other hand, when a cancel key 1704 is selected, a sheet type of the page is not replaced, and the needleless binding unexecutable sheet type replacement confirmation screen 1701 is closed.

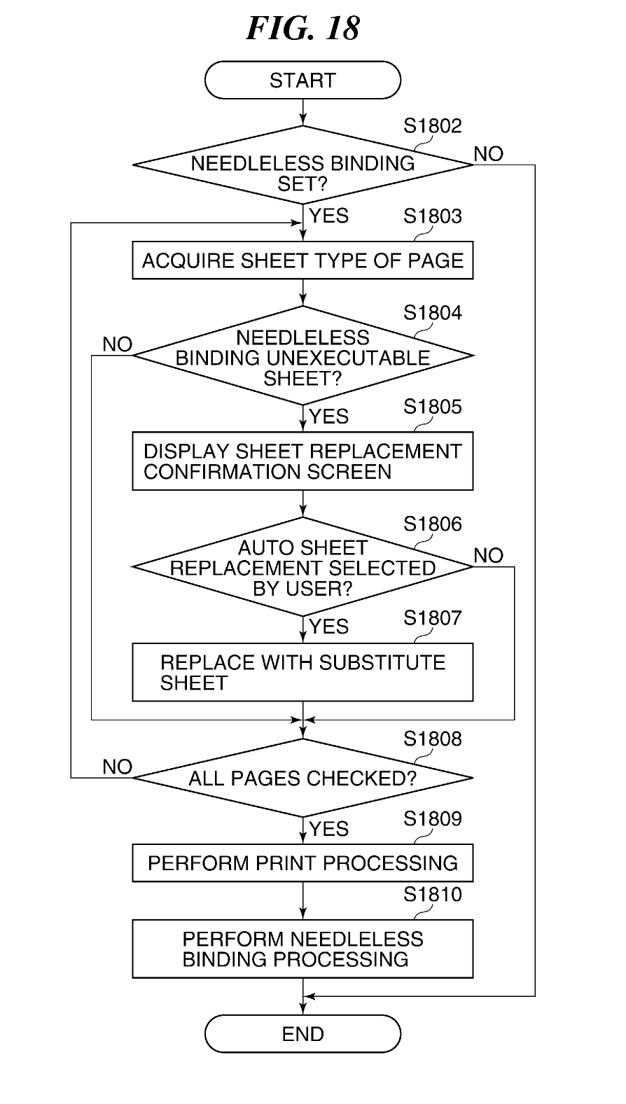

FIG. 18 is a flowchart of a replacement process performed in a case where the user can select, when a page is detected which is set to needleless binding and also which is set to a needleless binding unexecutable sheet, whether to perform replacement of a sheet type of the page, using the needleless binding unexecutable sheet type replacement confirmation screen 1701. S1802 to S1810 in FIG. 18 denote respective steps of the replacement process. The present process is realized by the CPU 103 which executes a control program loaded from the HDD 106 into the RAM 104. Note that steps S1803 to S1808 appearing in FIG. 18 are loop processing performed on each page of the print data. This loop processing is sequentially performed on all pages, in an order starting from the leading page of the print data.

In the step S1802, the PDL processor 202 determines based on the print settings of the print data whether or not needleless binding has been set. If needleless binding has been set, the process proceeds to the step S1803. On the other hand, if needleless binding has not been set, the present process is immediately terminated, and thereafter, print processing and post-processing are performed based on the print settings of the print data.

In the step S1803, the PDL processor 202 acquires a sheet type set for a target page of the print data, and inquires the needleless binding executability determination section 204 about needleless binding executability of the acquired sheet type.

In a step S1804, the needleless binding executability determination section 204 refers to the sheet information list 701 via the sheet information management section 203, and determines whether or not the sheet type acquired in the step S1803 is needleless binding unexecutable. If the sheet type acquired in the step S1803 is needleless binding unexecutable, the process proceeds to a step S1805. On the other hand, if the sheet type acquired in the step S1803 is needleless binding executable, the process proceeds to the step S1808.

In the step S1805, the PDL processor 202 displays the needleless binding unexecutable sheet type replacement confirmation screen 1701 on the touch panel of the console section 110 of the image forming apparatus 101, and prompts the user to select whether or not to perform sheet type replacement of the page.

In the step S1806, the PDL processor 202 determines whether or not the user has selected the replace key 1702 on the needleless binding unexecutable sheet type replacement confirmation screen 1701 displayed in the step S1805. If the replace key 1702 has been selected, the process proceeds to a step S1807, whereas if the not-replace key 1703 has been selected, the process proceeds to the step S1808.

In the step S1807, the PDL processor 202 acquires a sheet type set in the needleless binding unexecutable-time substitute sheet setting 708 of the sheet information list 701, and replaces the sheet type which has been determined in the step S1804 to be needleless binding unexecutable, with the acquired sheet type.

In the step S1808, the PDL processor 202 determines whether or not the loop processing on all pages of the print data has been completed. If the loop processing has not been completed, the process returns to the step S1803, whereas if the loop processing has been completed, the process proceeds to a step S1809.

In the step S1809, the print controller 206 gives a print instruction for printing print data generated by the RIP 107 to the printing section 114. The sheet type set by the replacement in the step S1807 is reflected on sheets to be used by the printing section 114.

In the step S1810, the post-processing section 115 performs post-processing on a bundle of sheets printed in the step S1809 according to the instruction from the print controller 206. For example, when needleless binding is set in the print data, needleless binding processing is performed. In doing this, as to sheets determined by the needleless binding executability determination section 204 to be needleless binding unexecutable, if the user has selected in the step S1806 to replace each needleless binding unexecutable sheet with a sheets which is needleless binding executable, all the sheets have been replaced with sheets of a needleless binding executable sheet type through the replacement process in the step S1807. Therefore, the post-processing section 115 is capable of preventing failure of needleless binding to provide printed matter as desired or substantially as desired by the user.

Although in the above-described first to fourth embodiments, the description has been given of the case where the post-processing section 115 is incorporated in the image forming apparatus 101, the post-processing section 115 may be provided as a separate post-processing apparatus (sheet processing apparatus) which is configured to be removable from the image forming apparatus 101. Further, although in the above-described second embodiment, the processes shown in FIGS. 12 to 14 have been separately described, they may be configured to be performed in the same process.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-145782, filed Jul. 16, 2014, and Japanese Patent Application No. 2015-123830, filed Jun. 19, 2015, which are hereby incorporated by reference wherein in their entirety.

What is claimed is:

1. An image forming apparatus comprising:
a printing unit configured to be capable of printing images on sheets of a plurality of types;
a feeding unit configured to feed a sheet of a designated type to said printing unit; and
a control unit configured to, in a case where binding processing is designated for a bundle of sheets on which images are to be printed by said printing unit, and also the sheet of the designated type is a sheet which cannot be bound by the binding processing, control said feeding unit to feed a sheet which can be bound by the binding processing in place of the sheet of the designated type.

2. The image forming apparatus according to claim 1, wherein the binding processing is needleless binding which binds a bundle of sheets without using a needle.

3. The image forming apparatus according to claim 1, further comprising:
a storage unit configured to store information on types of sheets which can be bound by the binding processing, and
a determination unit configured to determine based on the information stored in said storage unit whether or not a sheet of the designated type is a sheet which can be bound by the binding processing.

4. The image forming apparatus according to claim 1, wherein in a case where binding processing is designated for a bundle of sheets on which images are to be printed by said printing unit, and also a type of a sheet which cannot be bound by the binding processing is designated for a specific page, said control unit controls said feeding unit to feed, as a sheet to be used for printing the specific page, out of sheets of a plurality types which can be bound by the binding processing, a sheet of the same type as a type of a sheet to be used for printing a leading page.

5. The image forming apparatus according to claim 1, wherein in a case where binding processing is designated for a bundle of sheets on which images are to be printed by said printing unit, and also a type of a sheet which cannot be bound by the binding processing is designated for a specific page, said control unit controls said feeding unit to feed, as a sheet to be used for printing the specific page, out of sheets of a plurality types which can be bound by the binding processing, a sheet of the same type as a type of a sheet to be used for printing a page immediately preceding the specific page.

6. The image forming apparatus according to claim 1, wherein in a case where binding processing is designated for a bundle of sheets on which images are to be printed by said printing unit, and also a type of a sheet which cannot be bound by the binding processing is designated for a specific page, said control unit controls said feeding unit to feed, as a sheet to be used for printing the specific page, out of sheets of a plurality types which can be bound by the binding processing, a sheet of the same type as a type of a sheet to be used for printing a page immediately following the specific page.

7. The image forming apparatus according to claim 1, further comprising a setting unit configured to set a first mode or a second mode,
wherein said control unit controls,
when the first mode is set, in a case where binding processing is designated for a bundle of sheets on which images are to be printed by said printing unit, and also the sheet of the designated type is a sheet which cannot be bound by the binding processing, said feeding unit to feed a sheet of a type which can be bound by the binding processing in place of the sheet of the designated type, and
when the second mode is set, even in a case where binding processing is designated for a bundle of sheets on which images are to be printed by said printing unit, and also the sheet of the designated type is a sheet which cannot be bound by the binding processing, said feeding unit to feed the sheet of the designated type.

8. The image forming apparatus according to claim 1, further comprising:
a determination unit configured to determine whether or not a sheet of the designated type is a sheet which cannot be bound by the binding processing, and
an inquiry unit configured to inquire a user about whether to perform sheet type replacement, after said determination unit determines that the sheet of the designated type is a sheet which cannot be bound by the binding processing, and
wherein said control unit controls said feeding unit, based on a result of the inquiry, to feed a sheet which can be bound by the binding processing in place of the sheet of the designated type.

9. A method of controlling an image forming apparatus including a printing unit capable of printing images on sheets of a plurality of types, comprising:
feeding a sheet of a designated type to the printing unit; and
controlling, in a case where binding processing is designated for a bundle of sheets on which images are to be printed by the printing unit, and also the sheet of the designated type is a sheet which cannot be bound by the binding processing, said feeding to feed a sheet which can be bound by the binding processing in place of the sheet of the designated type.

10. A non-transitory computer-readable storage medium storing a computer-executable program for executing a method of controlling an image forming apparatus including a printing unit capable of printing images on sheets of a plurality of types,
wherein the method comprises:
feeding a sheet of a designated type to the printing unit; and
controlling, in a case where binding processing is designated for a bundle of sheets on which images are to be printed by the printing unit, and also the sheet of the designated type is a sheet which cannot be bound by the binding processing, said feeding to feed a sheet which can be bound by the binding processing in place of the sheet of the designated type.
